(19) United States
(12) Patent Application Publication
(10) Pub. No.: US 2021/0112434 A1
(43) Pub. Date: Apr. 15, 2021

(54) PRECONFIGURED GAPS FOR MEASUREMENTS BASED ON CONFIGURED BWPS

(71) Applicant: QUALCOMM Incorporated, San Diego, CA (US)

(72) Inventors: Awlok Singh JOSAN, San Francisco, CA (US); Valentin Alexandru GHEORGHIU, Tokyo (JP)

(21) Appl. No.: 17/003,839

(22) Filed: Aug. 26, 2020

Related U.S. Application Data
(60) Provisional application No. 62/914,931, filed on Oct. 14, 2019.

(51) Int. Cl. H04W 24/10; H04W 72/04; H04L 5/00

(52) U.S. Cl. CPC H04W 24/10; H04L 5/0048; H04W 72/04

(57) ABSTRACT

A configuration for pre-configuring a UE with a gap configuration for each possible BWP, to allow the UE to only use gaps needed to perform a measurement based on an active BWP of the UE. The apparatus receives a first configuration for one or more BWPs. The apparatus receives a second configuration for one or more gaps for one or more measurements. The apparatus receives an indication of an active BWP from the one or more BWPs. The apparatus determines whether to apply a gap of the one or more gaps based on the active BWP and a measurement to be performed for the one or more measurements.

### CROSS REFERENCE TO RELATED APPLICATION(S)

This application claims the benefit of U.S. Provisional Application Ser. No. 62/914,931, entitled “Preconfigured Gaps for Measurements based on Configured BWPs” and filed on Oct. 14, 2019, which is expressly incorporated by reference herein in its entirety.

### BACKGROUND

### Technical Field

The present disclosure relates generally to communication systems, and more particularly, to preconfigured gaps to conduct measurements.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a UE. The device may be a processor and/or a modem at a UE or the UE itself. The apparatus may enable a user equipment (UE) to determine whether to apply a gap in order to perform a measurement of a neighbor cell. The apparatus receives a first configuration for one or more bandwidth parts (BWPs). The apparatus receives a second configuration for one or more gaps for one or more measurements. The apparatus receives an indication of an active BWP from the one or more BWPs. The apparatus determines whether to apply a gap of the one or more gaps based on the active BWP and a measurement to be performed for the one or more measurements.

In an aspect of the disclosure, a method, a computer-readable medium, and an apparatus are provided. The apparatus may be a device at a base station. The device may be a processor and/or a modem at a base station or the base station itself. The apparatus may configure a UE with one or more gaps for one or more measurements. The apparatus configures a UE for one or more BWPs. The apparatus determines one or more gaps for one or more measurements in combination with the one or more BWPs. The apparatus configures the UE with the one or more gaps.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example of BWPs of a UE and a serving cell to be measured.

FIG. 5 is a call flow diagram of signaling between a UE and a base station in accordance with certain aspects of the disclosure.

FIG. 6 is a flowchart of a method of wireless communication.

FIG. 7 is a diagram illustrating an example of a hardware implementation for an example apparatus.

FIG. 8 is a flowchart of a method of wireless communication.

FIG. 9 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

A UE may perform different types of measurements, including intra-frequency measurements and inter-frequency measurements. For example, the UE may perform synchronization signal block (SSB) based measurements or channel state information reference signal (CSI-RS) based measurements. Intra-frequency measurements occur when the signal (such as the SSB) of the cell to be measured has the same frequency and the same subcarrier spacing (SCS) used for communication with the serving cell, whereas inter-frequency measurements may occur in all other instances. In some instances, a measurement gap may be needed by the UE in order to perform the measurement. A gap or gap period is a period of time during which the UE does not transmit or receive data to/from the serving cell in order to perform the measurement.

A gap configuration may be provided by the base station to the UE via radio resource control (RRC) signaling, and BWP configurations may be provided by the base station to the UE via RRC signaling. However, an active BWP may be indicated to the UE via downlink control information (DCI). As such, the active BWP can change in a more dynamic manner than the gap configuration. In some instances, a UE may experience a change in the active BWP such that the existing gap configuration is not compatible with the new, active BWP. Aspects provided herein improve the use of gaps in communication for the UE to perform measurements and address the dynamic nature of the active BWP for the UE.

As presented herein, a UE may determine whether to apply a gap based on an active BWP and a measurement to be performed. The UE may receive a first configuration for one or more BWPs and a second configuration for one or more gaps for measurements. The UE may receive an indication of an active BWP from the one or more BWPs and may determine whether to use a gap, or the gap configuration to use, based on the active BWP and the measurement to be performed.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

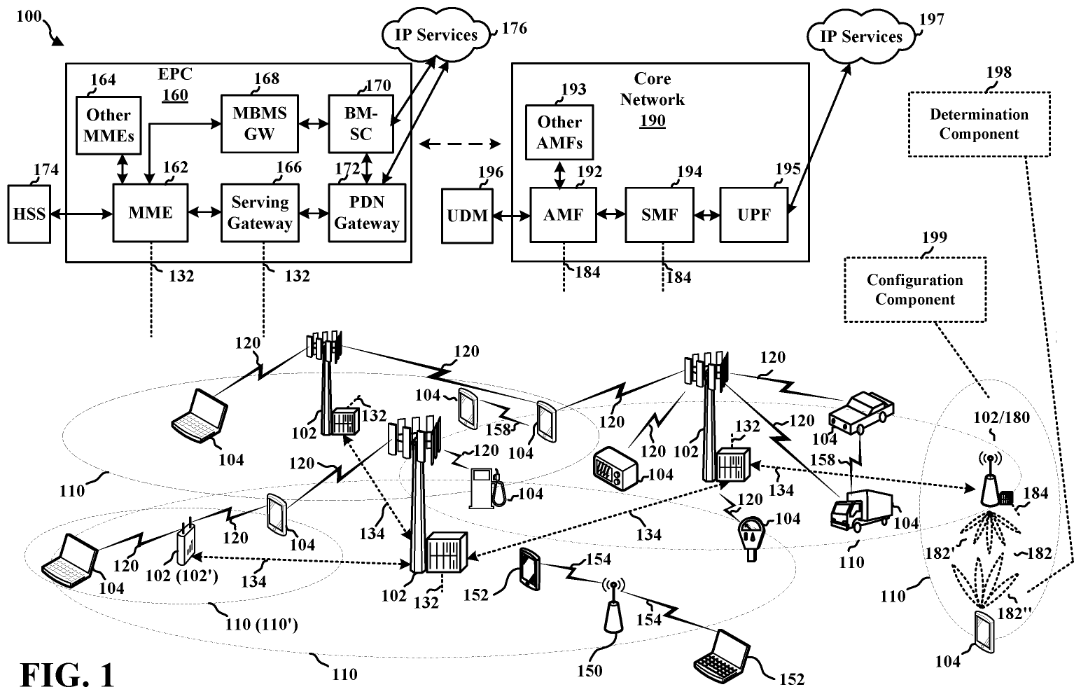

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may be configured to determine whether to apply a gap. For example, the UE 104 of FIG. 1 may include a determination component 198 configured to determine whether to apply a gap based on an active BWP and a measurement to be performed. The UE 104 may receive a first configuration for one or more BWPs. The UE 104 may receive a second configuration for one or more gaps for one or more measurements. The UE 104 may receive an indication of an active BWP from the one or more BWPs. Then, the UE may determine, e.g., using the determination component 198, whether to apply a gap of the one or more gaps based on the active BWP and a measurement to be performed for the one or more measurements.

Referring again to FIG. 1, in certain aspects, the base station 102/180 may be configured to configure a UE with one or more gaps. For example, the base station 102/180 of FIG. 1 may include a configuration component 199 configured to configure a UE with one or more gaps. The base station 102/180 may configure a UE for one or more BWPs. The base station 102/180 may determine one or more gaps for one or more measurements in combination with the one or more BWPs.

Although the following description may be focused on 5G NR, the concepts described herein may be applicable to other similar areas, such as LTE, LTE-A, CDMA, GSM, and other wireless technologies.

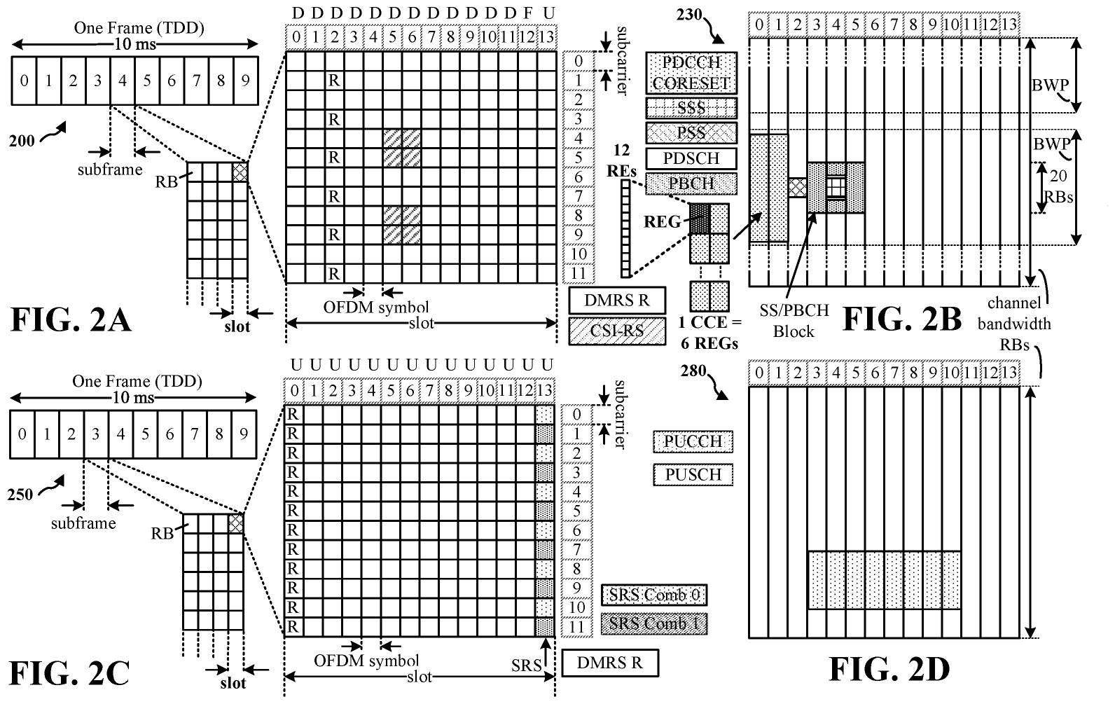

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) ACK/NACK feedback. The PUSCH carries data, and may additionally be used to carry a buffer status report (BSR), a power headroom report (PHR), and/or UCI.

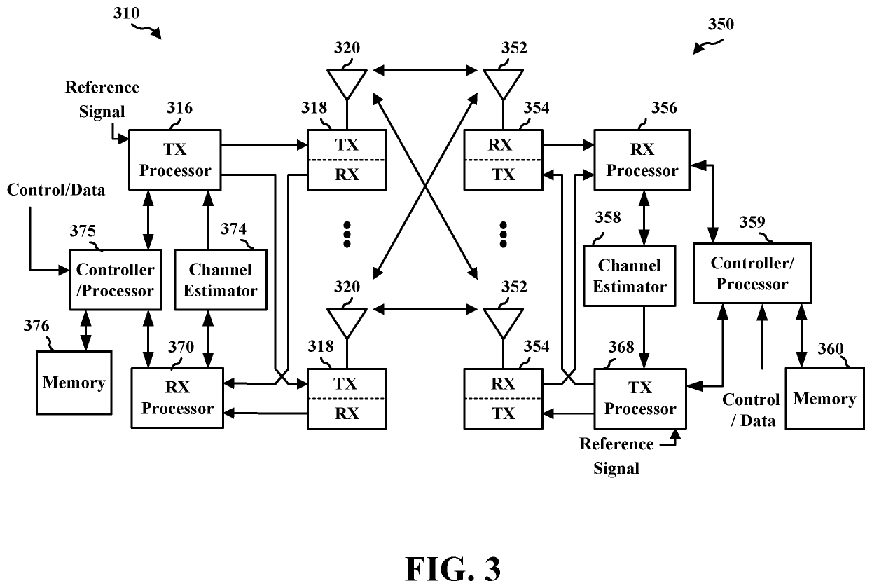

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate an RF carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

A UE may performed different types of measurements, including intra-frequency measurements and inter-frequency measurements. For example, the UE may perform SSB based measurements or channel state information reference signal (CSI-RS) based measurements. Intra-frequency measurements occur when the signal (such as the SSB) of the cell to be measured has the same frequency and the same subcarrier spacing (SCS) used for communication with the serving cell, whereas inter-frequency measurements may occur in all other instances. In some instances, a measurement gap may be needed by the UE in order to perform the measurement. A gap or gap period is a period of time during which the UE does not transmit or receive data to/from the serving cell in order to perform the measurement. For example, for intra-frequency measurements, if the SSB of the cell to be measured (e.g., neighbor cell) is within the active bandwidth part (BWP) of the UE, then the UE does not need a gap. However, if the SSB of the cell to be measured (e.g., neighbor cell) is outside or not within the active BWP, then the UE will need one or more gaps to perform the measurement. For inter-frequency measurements, the UE may need to be configured with one or more gaps by the network in order to perform the measurements.

The gap configurations may be provided by the base station to the UE via radio resource control (RRC) signaling, and the BWP configurations may also be provided by the base station to the UE via RRC signaling. In contrast, the active BWP may be indicated to the UE via downlink control information (DCI). As such, the active BWP can change in a more dynamic manner than the gap configuration because it can be indicated via DCI, which is more dynamic than RRC signaling. The configurations for the BWP and the gaps may not switch as frequently as the active BWP. In some instances, a UE may experience a change in the active BWP such that the existing gap configuration is not compatible with the new or changed active BWP. Aspects provided herein improve the use of gaps in communication for the UE to perform measurements and address the dynamic nature of the active BWP for the UE.

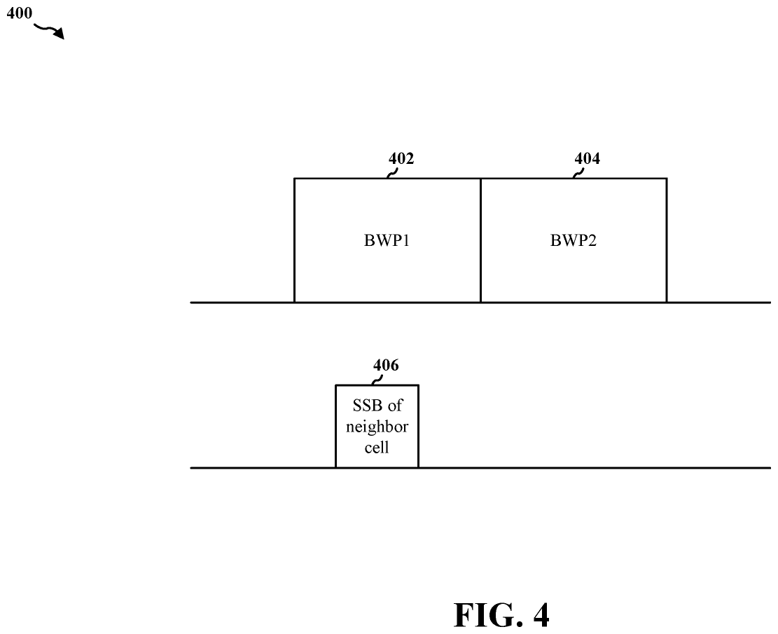

The UE may use one or more gaps to measure the frequency of the cell to be measured (e.g., neighbor cell) based on the active BWP of the UE. For example, with reference to FIG. 4, when a UE's active BWP is BWP1 402, the UE may measure the SSB of the neighbor cell 406 without a gap because the SSB of the neighbor cell 406 is within BWP1 402. However, when the UE's active BWP is BWP2 404, the UE may need a gap to measure the SSB of the neighbor cell 406 because the SSB of the neighbor cell 406 is outside or not within the active BWP (e.g., BWP2 404).

The network may configure the UE with the BWPs and measurements (e.g., measurement objects (MO)) to be performed by the UE. Therefore, the network may know the potential combinations of BWP and measurements for which the UE may need a gap to perform the measurements. The network may pre-configure the UE with a configuration of gaps that may potentially be used for each possible BWP. The pre-configuration of the possible gaps allows the network or base station to avoid configuring gaps every time the active BWP of the UE changes. Thus, with the UE being pre-configured with the configuration of gaps for each possible BWP, the UE may use a particular pre-configured gap for a particular inter-frequency measurement that falls outside of the active BWP. The pre-configuration of potential gaps may help reduce signaling from the network because the network may provide the configuration once, rather than transmitting an updated gap configuration each time the active BWP changes. Pre-configuring the UE with a set of gaps for each possible BWP may reduce signaling overhead and improve measurement efficiency.

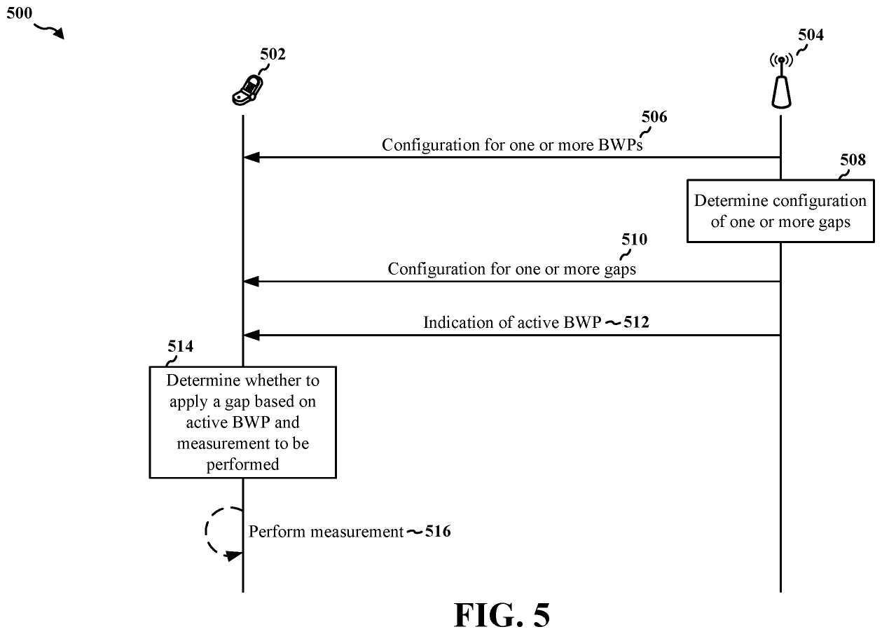

FIG. 5 illustrates an example communication flow 500 between a UE 502 and a base station 504. The base station 504 may provide a cell serving the UE 502. For example, in the context of FIG. 1, the base station 504 may correspond to base station 102/180 and, accordingly, the cell may include a geographic coverage area 110 in which communication coverage is provided and/or small cell 102′ having a coverage area 110′. Further, the UE 502 may correspond to at least UE 104. In another example, in the context of FIG. 3, the base station 504 may correspond to the base station 310 and the UE 502 may correspond to the UE 350.

The base station 504 may configure the UE 502 for one or more BWPs. The base station 504 may configure the UE 502 for the one or more BWPs by transmitting the configuration (e.g., 506) to the UE. The configuration of the one or more BWPs may be arranged as a first configuration. As such, the UE 502 receives the first configuration, from the base station 504, for the one or more BWPs.

The base station 504, at 508, may determine one or more gaps for measurement(s) that may be performed by the UE 502. The one or more gaps for the measurement(s) may be determined in combination with the one or more BWPs. The base station 504 may determine which of the one or more BWPs may need one or more gaps in order for the UE 502 to perform the measurement(s). In some aspects, the measurement(s) may include a neighbor cell measurement, a CSI-RS measurement, an SSB measurement, or the like.

The base station 504 may configure the UE 502 with the gap(s). The base station 504 may configure the UE 502 with the gap(s) by transmitting the configuration (e.g., 510) of the gap(s) to the UE 502. The configuration of the gap(s) for the measurement(s) may be arranged as a second configuration. As such, the UE 502 receives the second configuration, from the base station 504, for the gap(s) for the measurement(s). In some aspects, the UE 502 receiving the second configuration may include receiving configurations for a plurality of sets of gaps. In some aspects, a first set of gaps of the plurality of sets of gaps may correspond to an active BWP of the one or more BWPs. In some aspects, a second set of gaps of the plurality of sets of gaps may correspond to a second BWP of the one or more BWPs.

In some aspects, the UE, at 512, may receive an indication of an active BWP from the one or more BWPs. The UE 502 may receive the indication of the active BWP from the base station 504.

The UE 502, at 514, may determine whether to apply a gap of the one or more gaps. The UE 502 may determine to apply the gap of the one or more gaps based on the active BWP and the measurement to be performed for the one or more measurements. In some aspects, the UE 502 in determining whether to apply the gap may be configured to select a first set of gaps of the plurality of sets of gaps for applying the gaps for the active BWP. The selected first set of the plurality of sets may be used to perform the one or more measurements. In some aspects the one or more measurements may include a neighbor cell measurement. The UE 502, in some aspects, may determine to not apply the gap to perform the neighbor cell measurement when a frequency for the neighbor cell measurement is within the active BWP. The UE 502, in some aspects, may determine to apply the gap to perform the neighbor cell measurement when a frequency for the neighbor cell measurement is not within the active BWP.

In some aspects, the one or more measurements may include at least one of a CSI-RS measurement or an SSB measurement. The UE 502 may determine to apply the gap for the CSI-RS measurement of the SSB measurement based on the frequency of the CSI-RS measurement or the SSB measurement and the active BWP. In some aspects, the UE, 502 may determine whether the frequency of the CSI-RS measurement or the SSB measurement is within the active BWP in order to determine whether to apply the gap or not. In aspects where the frequency of the CSI-RS measurement or the SSB measurement is within the active BWP, the UE does not apply the gap. In aspects where the frequency for the CSI-RS measurement or the SSB measurement is not within the active BWP, the UE determines to apply the gap. The UE 502 may apply the gap in order to perform the CSI-RS measurement or the SSB measurement.

Upon the determination of whether to apply the gap, the UE 502 may perform the measurement, at 516. In some aspects, data is not sent to the UE 502, from the base station 504, when the UE 502 uses the gap to perform the measurement. The base station 504 does not transmit data to the UE 502 during the gap period based on the base station 504 providing the configuration of the one or more BWPs and the one or more gaps for the one or more measurements. The base station 504 knows when the UE 502 will use the gap based on the configuration provided to the UE 502, and thus refrains from sending data during the gap period in order to allow the UE to perform the measurement.

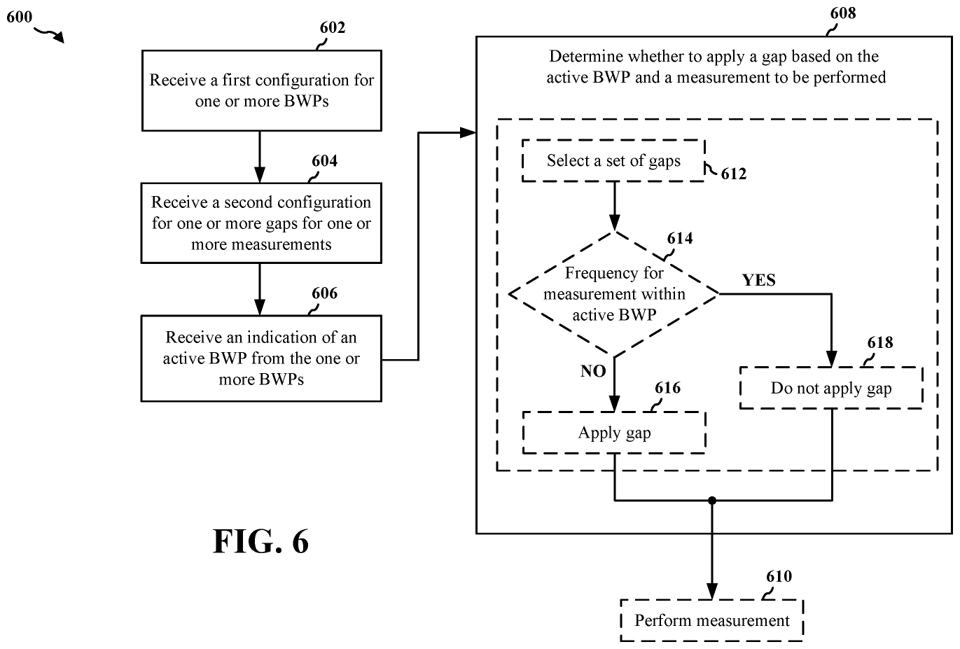

FIG. 6 is a flowchart 600 of a method of wireless communication. The method may be performed by a UE or a component of a UE (e.g., the UE 104; the apparatus 702; the cellular baseband processor 704, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous. Optional aspects are illustrated with a dashed line. The method may enable a UE to determine whether to apply a gap in order to perform a measurement of a neighboring cell.

At 602, the UE may receive a first configuration for one or more BWPs. For example, 602 may be performed by BWP configuration component 740 of apparatus 702. The UE may receive the first configuration for the one or more BWPs from a base station (e.g., base station 750).

At 604, the UE may receive a second configuration for one or more gaps. For example, 604 may be performed by gap configuration component 742 of apparatus 702. The second configuration may be for one or more gaps for one or more measurements. In some aspects, the UE receiving the second configuration may include receiving configurations for a plurality of sets of gaps. In some aspects, a first set of gaps of the plurality of sets of gaps may correspond to an active BWP of the one or more BWPs. In some aspects, a second set of gaps of the plurality of sets of gaps may correspond to a second BWP of the one or more BWPs. In some aspects, the first set of gaps of the plurality of sets of gaps may correspond to the second BWP, while the second set of gaps of the plurality of sets of gaps may correspond to the active BWP.

At 606, the UE may receive an indication of an active BWP from the one or more BWPs. For example, 606 may be performed by indication component 744 of apparatus 702. The UE may receive the indication of the active BWP from the base station (e.g., base station 750).

At 608, the UE may determine whether to apply a gap of the one or more gaps. For example, 608 may be performed by determination component 746 of apparatus 702. The UE may determine whether to apply the gap of the one or more gaps based on the active BWP and a measurement to be performed for the one or more measurements. In some aspects, in determining whether to apply the gap, the UE, at 612, may select a set of gaps. In some aspects, the UE may select a first set of gaps of the plurality of sets for applying the gaps for the active BWP. The selected first set of gaps of the plurality of sets may be used to perform the one or more measurements.

In some aspects, the one or more measurements may include a neighbor cell measurement. In such aspects, the UE may determine whether to apply the gap for the neighbor cell measurement based on the frequency to be measured of the neighbor cell and the active BWP. For example, to determine whether to apply the gap at 608, the UE, at 614, may determine whether the frequency of the neighbor cell is within the active BWP. In instances where the frequency for the neighbor cell measurement is within the active BWP, the UE does not apply the gap, for example, at 618. In instances where the frequency for the neighbor cell measurement is not within the active BWP, the UE determines to apply the gap, for example at 616. The UE may apply the gap to perform the neighbor cell measurement when the frequency for the neighbor cell measurement is not within the active BWP.

In some aspects, the one or more measurements may include at least one of a CSI-RS measurement or an SSB measurement. In such aspects, the UE may determine whether to apply the gap for the CSI-RS measurement of the SSB measurement based on the frequency of the CSI-RS measurement or the SSB measurement and the active BWP. For example, to determine whether to apply the gap at 608, the UE, at 614, may determine whether the frequency of the CSI-RS measurement or the SSB measurement is within the active BWP. In instances where the frequency of the CSI-RS measurement or the SSB measurement is within the active BWP, the UE does not apply the gap, for example, at 618. In instances where the frequency for the CSI-RS measurement or the SSB measurement is not within the active BWP, the UE determines to apply the gap, for example at 616. The UE may apply the gap in order to perform the CSI-RS measurement or the SSB measurement.

In some aspects, for example at 610, the UE may perform the one or more measurements. For example, 610 may be performed by measurement component 748 of apparatus 702. In some aspects, the one or more measurements may comprise measurement objects (MOs). MOs may comprise a list of objects of which the UE is to perform measurements, such as but not limited to, carrier frequencies.

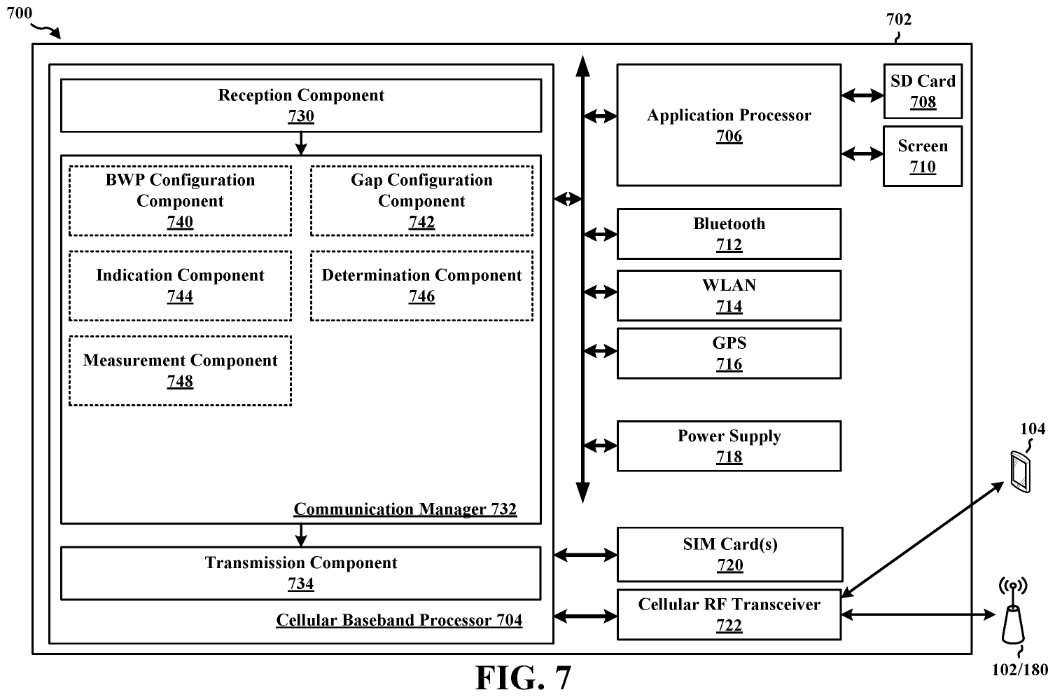

FIG. 7 is a diagram 700 illustrating an example of a hardware implementation for an apparatus 702. The apparatus 702 is a UE and includes a cellular baseband processor 704 (also referred to as a modem) coupled to a cellular RF transceiver 722 and one or more subscriber identity modules (SIM) cards 720, an application processor 706 coupled to a secure digital (SD) card 708 and a screen 710, a Bluetooth module 712, a wireless local area network (WLAN) module 714, a Global Positioning System (GPS) module 716, and a power supply 718. The cellular baseband processor 704 communicates through the cellular RF transceiver 722 with the UE 104 and/or BS 102/180. The cellular baseband processor 704 may include a computer-readable medium/memory. The computer-readable medium/memory may be non-transitory. The cellular baseband processor 704 is responsible for general processing, including the execution of software stored on the computer-readable medium/memory. The software, when executed by the cellular baseband processor 704, causes the cellular baseband processor 704 to perform the various functions described supra. The computer-readable medium/memory may also be used for storing data that is manipulated by the cellular baseband processor 704 when executing software. The cellular baseband processor 704 further includes a reception component 730, a communication manager 732, and a transmission component 734. The communication manager 732 includes the one or more illustrated components. The components within the communication manager 732 may be stored in the computer-readable medium/memory and/or configured as hardware within the cellular baseband processor 704. The cellular baseband processor 704 may be a component of the UE 350 and may include the memory 360 and/or at least one of the TX processor 368, the RX processor 356, and the controller/processor 359. In one configuration, the apparatus 702 may be a modem chip and include just the baseband processor 704, and in another configuration, the apparatus 702 may be the entire UE (e.g., see 350 of FIG. 3) and include the aforediscussed additional modules of the apparatus 702.

The communication manager 732 includes a BWP configuration component 740 that is configured to receive a first configuration for one or more BWPs, e.g., as described in connection with 602 of FIG. 6. The communication manager 732 further includes a gap configuration component 742 that is configured to receive a second configuration for one or more gaps, e.g., as described in connection with 604 of FIG. 6. The communication manager 732 further includes an indication component 744 that is configured to receive an indication of an active BWP from the one or more BWPs, e.g., as described in connection with 606 of FIG. 6. The communication manager 732 further includes a determination component 746 that is configured to determine whether to apply a gap of the one or more gaps, e.g., as described in connection with 608 of FIG. 6. The communication manager 732 further includes a measurement component 748 that is configured to perform the one or more measurements, e.g., as described in connection with 610 of FIG. 6.

The apparatus may include additional components that perform each of the blocks of the algorithm in the aforementioned flowchart of FIG. 6. As such, each block in the aforementioned flowchart of FIG. 6 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 702, and in particular the cellular baseband processor 704, includes means for means for receiving a first configuration for one or more BWPs. The apparatus includes means for receiving a second configuration for one or more gaps for one or more measurements. The apparatus includes means for receiving an indication of an active BWP from the one or more BWPs. The apparatus includes means for determining whether to apply a gap of the one or more gaps based on the active BWP and a measurement to be performed for the one or more measurements. The means for receiving the second configuration is configured to receive configurations for a plurality of sets of gaps. The means for determining whether to apply the gaps is configured to select a first set of the plurality of sets for applying the gaps for the active BWP. The selected first set of the plurality of sets is used to perform the one or more measurements. The aforementioned means may be one or more of the aforementioned components of the apparatus 702 configured to perform the functions recited by the aforementioned means. As described supra, the apparatus 702 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

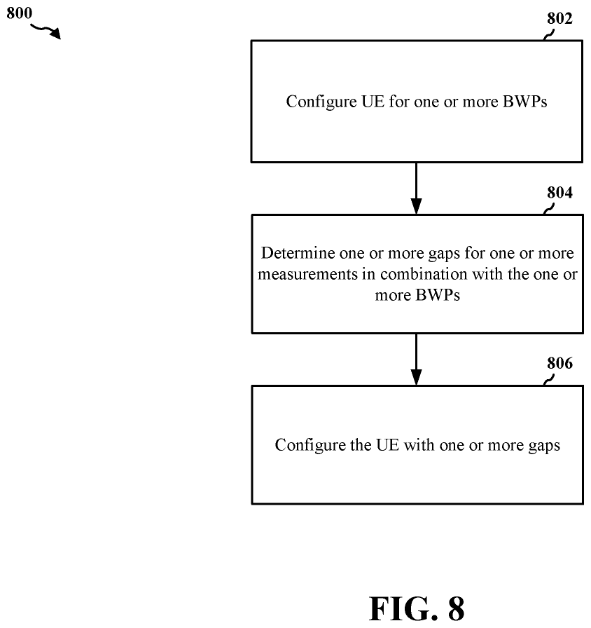

FIG. 8 is a flowchart 800 of a method of wireless communication. The method may be performed by a base station or a component of a base station (e.g., the base station 102/180; the apparatus 902; the baseband unit 904, which may include the memory 376 and which may be the entire base station 310 or a component of the base station 310, such as the TX processor 316, the RX processor 370, and/or the controller/processor 375). One or more of the illustrated operations may be omitted, transposed, or contemporaneous. Optional aspects are illustrated with a dashed line. The method may allow a base station to configure a UE with one or more gaps to perform one or more measurements.

At 802, the base station may configure a UE for one or more BWPs. For example, 802 may be performed by BWP configuration component 940 of apparatus 902. The base station may configure the UE for the one or more BWPs by transmitting the configuration to the UE. The configuration of the one or more BWPs may be arranged as a first configuration, such that the UE receives the first configuration, from the base station, for the one or more BWPs.

At 804, the base station may determine one or more gaps for one or more measurements. For example, 804 may be performed by determination component 942 of apparatus 902. The base station may determine the one or more gaps for the one or more measurements in combination with the one or more BWPs. In some aspects, the one or more measurements may include a neighbor cell measurement. In some aspects, the one or more measurements may include a CSI-RS measurement.

At 806, the base station may configure the UE with the one or more gaps. For example, 806 may be performed by gap configuration component 944 of apparatus 902. The base station may configure the UE with the one or more gaps by transmitting the gap configuration to the UE. In some aspects, data is not sent to the UE, from the base station, when the UE uses the gap to perform a measurement. The base station refraining from transmitting data to the UE during the gap, allows the UE to perform the one or more measurements, such as the neighbor cell measurement, the CSI-RS measurement, or the like.

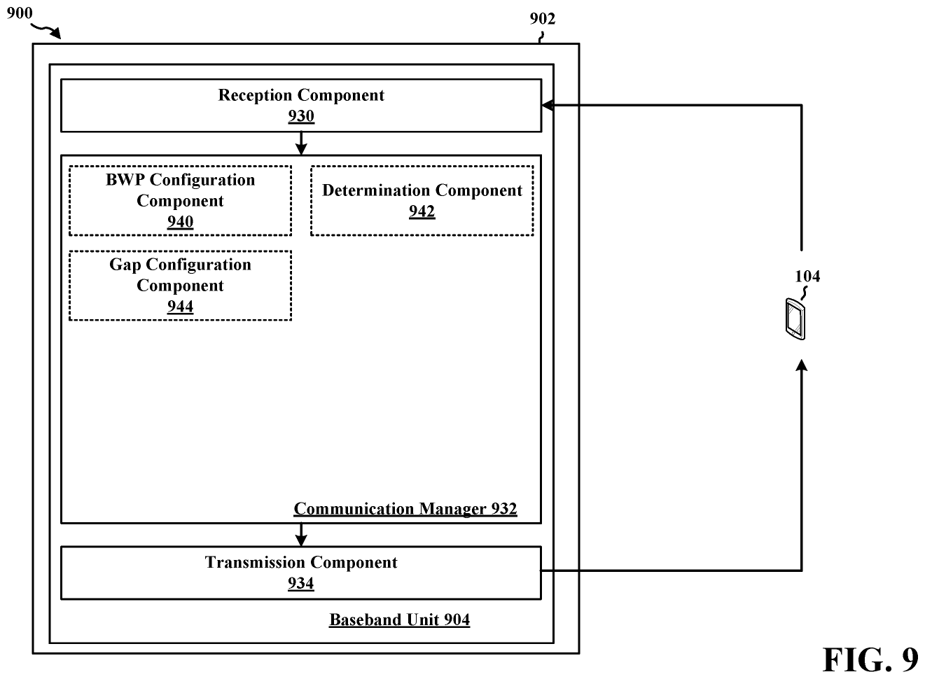

FIG. 9 is a diagram 900 illustrating an example of a hardware implementation for an apparatus 902. The apparatus 902 is a BS and includes a baseband unit 904. The baseband unit 904 may communicate through a cellular RF transceiver with the UE 104. The baseband unit 904 may include a computer-readable medium/memory. The baseband unit 904 is responsible for general processing, including the execution of software stored on the computer-readable medium/memory. The software, when executed by the baseband unit 904, causes the baseband unit 904 to perform the various functions described supra. The computer-readable medium/memory may also be used for storing data that is manipulated by the baseband unit 904 when executing software. The baseband unit 904 further includes a reception component 930, a communication manager 932, and a transmission component 934. The communication manager 932 includes the one or more illustrated components. The components within the communication manager 932 may be stored in the computer-readable medium/memory and/or configured as hardware within the baseband unit 904. The baseband unit 904 may be a component of the BS 310 and may include the memory 376 and/or at least one of the TX processor 316, the RX processor 370, and the controller/processor 375.

The communication manager 932 includes a BWP configuration component 940 that may configure a UE for one or more BWPs e.g., as described in connection with 902 of FIG. 9. The communication manager 932 further includes a determination component 942 that may determine one or more gaps for one or more measurements, e.g., as described in connection with 904 of FIG. 9. The communication manager 932 further includes a gap configuration component 944 that may configure the UE with one or more gaps, e.g., as described in connection with 906 of FIG. 9.

The apparatus may include additional components that perform each of the blocks of the algorithm in the aforementioned flowchart of FIG. 9. As such, each block in the aforementioned flowchart of FIG. 9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 902, and in particular the baseband unit 904, includes means for configuring a UE for one or more BWPs. The apparatus includes means for determining one or more gaps for one or more measurements in combination with the one or more BWPs. The apparatus includes means for configuring the UE with the one or more gaps. The aforementioned means may be one or more of the aforementioned components of the apparatus 902 configured to perform the functions recited by the aforementioned means. As described supra, the apparatus 902 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

The present disclosure relates to aligning the UE and the base station as to when the UE would need gaps for active BWPs. The base station may preconfigure the UE with a configuration of gaps for each possible BWP, such that the UE will use the gaps as needed, and will not require the network to provide a gap configuration each time the active BWP of the UE changes. The network will only need to provide the configuration once, instead of every time the active BWP changes. At least one advantage of the disclosure is that pre-configuring the UE with the configuration of gaps for each possible BWP may reduce signaling overhead and improve measurement efficiency.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The following examples are illustrative only and may be combined with aspects of other embodiments or teachings described herein, without limitation.

Example 1 is a method of wireless communication at a UE comprising receiving a first configuration for one or more BWPs; receiving a second configuration for one or more gaps for one or more measurements; receiving an indication of an active BWP from the one or more BWPs; and determining whether to apply a gap of the one or more gaps based on the active BWP and a measurement to be performed for the one or more measurements.

In Example 2, the method of Example 1 further includes the receiving the second configuration includes receiving configurations for a plurality of sets of gaps.

In Example 3, the method of Example 1 or 2 further includes the determining whether to apply the gap includes selecting a first set of the plurality of sets of gaps for applying the gap for the active BWP, wherein the selected first set of the plurality of sets of gaps is used to perform the one or more measurements.

In Example 4, the method of Example 1 or 2 further includes a first set of the plurality of sets of gaps corresponds to the active BWP of the one or more BWPs.

In Example 5, the method of Example 4 further includes a second set of the plurality of sets of gaps corresponds to a second BWP of the one or more BWPs.

In Example 6, the method of any of Examples 1-5 further includes that the one or more measurements include a neighbor cell measurement.

In Example 7, the method of any of Examples 1-6 further includes that the UE does not apply the gap when a frequency for the neighbor cell measurement is within the active BWP.

In Example 8, the method of any of Examples 1-6 further includes that a frequency for the neighbor cell measurement is not within the active BWP, and the UE determines to apply the gap in order to perform the neighbor cell measurement.

In Example 9, the method of any of Examples 1-8 further includes that the one or more measurements include at least one of a CSI-RS measurement or an SSB measurement, wherein the UE determines whether to apply the gap based on the active BWP and a frequency of a CSI-RS or SSB to be measured.

In Example 10, the method of any of Examples 1-9 further includes that the UE does not apply the gap when the frequency of the CSI-RS or SSB is within the active BWP.

In Example 11, the method of any of Examples 1-9 further includes that the UE determines to apply the gap when the frequency of the CSI-RS or SSB is not within the active BWP.

Example 12 is a system or apparatus including means for implementing a method or realizing an apparatus as in any of examples 1-11.

Example 13 is a system including one or more processors and memory in electronic communication with the one or more processors to cause the system or apparatus to implement a method as in any of examples 1-11.

Example 14 is a non-transitory computer readable medium storing instructions executable by one or more processors to cause the one or more processors to implement a method as in any of examples 1-11.

Example 15 is a method of wireless communication at a base station comprising configuring a UE for one or more BWPs; determining one or more gaps for one or more measurements in combination with the one or more BWPs; and configuring the UE with the one or more gaps.

In Example 16, the method of Example 15 further includes that the one or more measurements include a neighbor cell measurement.

In Example 17, the method of Example 15 or 16 further includes that the one or more measurements include a CSI-RS measurement.

In Example 18, the method of any of Examples 15-17 further includes that data is not sent to the UE, from the base station, when the UE uses a gap to perform a measurement.

Example 19 is a system or apparatus including means for implementing a method or realizing an apparatus as in any of examples 15-18.

Example 20 is a system including one or more processors and memory in electronic communication with the one or more processors to cause the system or apparatus to implement a method as in any of examples 15-18.

Example 21 is a non-transitory computer readable medium storing instructions executable by one or more processors to cause the one or more processors to implement a method as in any of examples 15-18.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication at a user equipment (UE), comprising:
receiving a first configuration for one or more bandwidth parts (BWPs);
receiving a second configuration for one or more gaps for one or more measurements;
receiving an indication of an active BWP from the one or more BWPs; and
determining whether to apply a gap of the one or more gaps based on the active BWP and a measurement to be performed of the one or more measurements.

2. The method of claim 1, wherein receiving the second configuration includes receiving configurations for a plurality of sets of gaps.

3. The method of claim 2, wherein determining whether to apply the gap includes selecting a first set of the plurality of sets of gaps for applying the gap for the active BWP, wherein the selected first set of the plurality of sets of gaps is used to perform the one or more measurements.

4. The method of claim 2, wherein a first set of the plurality of sets of gaps corresponds to the active BWP of the one or more BWPs.

5. The method of claim 4, wherein a second set of the plurality of sets of gaps corresponds to a second BWP of the one or more BWPs.

6. The method of claim 1, wherein the one or more measurements include a neighbor cell measurement.

7. The method of claim 6, wherein the UE does not apply the gap when a frequency for the neighbor cell measurement is within the active BWP.

8. The method of claim 6, wherein a frequency for the neighbor cell measurement is not within the active BWP, and the UE determines to apply the gap in order to perform the neighbor cell measurement.

9. The method of claim 1, wherein the one or more measurements include at least one of a CSI-RS measurement or a synchronization signal block (SSB) measurement, wherein the UE determines whether to apply the gap based on the active BWP and a frequency of a CSI-RS or SSB to be measured.

10. The method of claim 9, wherein the UE does not apply the gap when the frequency of the CSI-RS or SSB is within the active BWP.

11. The method of claim 9, wherein the UE determines to apply the gap when the frequency of the CSI-RS or SSB is not within the active BWP.

12. An apparatus for wireless communication at a user equipment (UE), comprising:
a memory; and
at least one processor coupled to the memory and configured to:
receive a first configuration for one or more bandwidth parts (BWPs);
receive a second configuration for one or more gaps for one or more measurements;
receive an indication of an active BWP from the one or more BWPs; and
determine whether to apply a gap of the one or more gaps based on the active BWP and a measurement to be performed for the one or more measurements.

13. The apparatus of claim 12, wherein to receive the second configuration the at least one processor further configured to receive configurations for a plurality of sets of gaps.

14. The apparatus of claim 13, wherein to determine whether to apply the gap the at least one processor is configured to select a first set of the plurality of sets of gaps for applying the gap for the active BWP, wherein the selected first set of the plurality of sets of gaps is used to perform the one or more measurements.

15. The apparatus of claim 13, wherein a first set of the plurality of sets of gaps corresponds to the active BWP of the one or more BWPs.

16. The apparatus of claim 15, wherein a second set of the plurality of sets of gaps corresponds to a second BWP of the one or more BWPs.

17. The apparatus of claim 12, wherein the one or more measurements include a neighbor cell measurement.

18. The apparatus of claim 17, wherein the UE does not apply the gap when a frequency for the neighbor cell measurement is within the active BWP.

19. The apparatus of claim 17, wherein a frequency for the neighbor cell measurement is not within the active BWP, and the UE determines to apply the gap in order to perform the neighbor cell measurement.

20. The apparatus of claim 12, wherein the one or more measurements include at least one of a CSI-RS measurement or a synchronization signal block (SSB) measurement, wherein the UE determines whether to apply the gap based on the active BWP and a frequency of a CSI-RS or SSB to be measured.

21. The apparatus of claim 20, wherein the UE determines not to apply the gap is determined when the frequency of the CSI-RS or SSB is not within the active BWP.

22. The apparatus of claim 21, wherein the UE determines to apply the gap when the frequency of the CSI-RS or SSB is within the active BWP.

23. A method of wireless communication at a base station, comprising:
configuring a user equipment (UE) for one or more bandwidth parts (BWPs);
determining one or more gaps for one or more measurements in combination with the one or more BWPs; and
configuring the UE with the one or more gaps.

24. The method of claim 23, wherein the one or more measurements include a neighbor cell measurement.

25. The method of claim 23, wherein the one or more measurements include a CSI-RS measurement.

26. The method of claim 23, wherein data is not sent to the UE, from the base station, when the UE uses a gap to perform a measurement.

27. An apparatus for wireless communication at a base station, comprising:
a memory; and
at least one processor coupled to the memory and configured to:
configure a user equipment (UE) for one or more bandwidth parts (BWPs);
determine one or more gaps for one or more measurements in combination with the one or more BWPs; and
configure the UE with the one or more gaps.

28. The apparatus of claim 27, wherein the one or more measurements include a neighbor cell measurement.

29. The apparatus of claim 27, wherein the one or more measurements include a CSI-RS measurement.

30. The apparatus of claim 27, wherein data is not sent to the UE, from the base station, when the UE uses a gap to perform a measurement.
